(19) United States
(12) Patent Application Publication
(10) Pub. No.: US 2026/0034749 A1
(43) Pub. Date: Feb. 5, 2026

(54) FLAT SEMI-FINISHED PRODUCT WITH A PLASTIC MATRIX AND A THERMOPLASTIC FILM

(71) Applicant: nolax AG, Sempach Station (CH)

(72) Inventors: Raphael SCHALLER, Luzern (CH); Erik ROOS, Rothenburg (CH); Claude HOSOTTE, Michelbach le Haut (FR); Guntram WEILAND, Nottwil (CH)

(73) Assignee: nolax AG, Sempach Station (CH)

(21) Appl. No.: 19/100,363

(22) PCT Filed: Jul. 17, 2023
(86) PCT No.: PCT/EP2023/069804

§ 371 Date: Jan. 31, 2025

(30) Foreign Application Priority Data
Aug. 2, 2022 (EP) 22188299.6

(51) Int. Cl. B29C 70/20; B29K 75/00; B29K 105/08; B32B 5/12; B32B 27/12; B32B 27/40

(52) U.S. Cl. CPC B29C 70/20; B32B 5/12; B32B 27/12; B32B 27/40; B29K 2075/00; B29K 2105/0881; B32B 2260/021; B32B 2260/046

(57) ABSTRACT

A flat semi-finished product having-a matrix with at least one latently reactive plastic composition, which can be cured to form an elastomer, more particularly a thermoplastic elastomer,-continuous fibres embedded in the matrix. The fibres are aligned preferably unidirectionally. The flat semi-finished product further has a thermoplastic film. A method for producing a flat semi-finished product of this kind and the use of a flat semi-finished product of this kind.

The invention relates to a sheet-like semi-finished product, a method for manufacturing sheet-like semi-finished products and the use of a sheet-like semi-finished product according to the preamble of the independent claims.

Fiber-reinforced plastics are becoming increasingly important for the manufacturing of structural components. Such components are particularly suitable for use in motor sports, aerospace, rail vehicle and aircraft construction. For example, these components have a lower weight than conventional components made of steel, aluminum or wood while retaining the same performance, which leads to savings in energy and fuel consumption.

Fiber-reinforced plastics can be achieved, for example, by embedding fibers in a plastic matrix and then curing them. Thermosetting resin systems dominate as the plastic matrix. Alternatively, the fibers and the resin can be combined with suitable hardeners and stored in an uncured state. Cross-linking to form a fiber-reinforced plastic then only takes place at a later stage. Epoxy resins are typically used as resins. However, due to the presence of hardeners and accelerators in the resin matrix, these can only be stored for a limited time. To prevent premature cross-linking, such reactive systems are stored at low temperatures (approx. −20° C.) and must be thawed before further processing.

EP3330311 Al describes prepregs consisting of a fibrous material impregnated with latently reactive 1-component polyurethanes without a resin component for manufacturing composite components.

WO 2020/059476 A1 describes a fabric impregnated with cyanate esters, which can be used for manufacturing laminates laminated with metal foils, among other things.

WO 2019/088009 A1 describes a two-layer tape consisting of a layer of reactive adhesive and a reinforcing layer with aligned fibers. The matrix of the fiber reinforcement does not act as an adhesive.

WO 99/29755 A1 and EP3730528 Al describe latent reactive polyurethane systems based on encapsulated isocyanates and carbodiimides. They do not contain long fibers as fillers.

Fiber-reinforced self-adhesive tapes (duct tape, heavy duty tape) are generally known, also in versions with aligned (parallel) fibers, so-called filament tape. What these self-adhesive tapes have in common is that they are only applied by pressure and without temperature and that the fiber reinforcement, if it is in a separate layer at all, is not equipped with a latent reactive adhesive.

Long-fiber-reinforced composites are also known, which have a thermoplastic or thermoset (and already cross-linked) matrix. Such (continuous) fibers are aligned using the extrusion or pultrusion process.

WO 2018/234423 A1, for example, describes a sheet-like semi-finished product made of a plastic matrix with embedded, unidirectionally aligned, continuous fibers.

A major weakness of unidirectional tapes is their low stability in the direction transverse to the fiber. The matrix, which is not yet cross-linked, has a very low viscosity and therefore offers little resistance to shearing forces in the bonding or precoating process. The combination and variety of substrates that can be bonded are very limited.

It is therefore at least one task of the invention to overcome the disadvantages of the prior art. In particular, it is a task of the invention to provide a sheet-like semi-finished product which has a particularly high stability and enables a high substrate diversity. It is also a task of the invention to provide a method for manufacturing such a sheet-like semi-finished product as well as a use of such a product.

These tasks are solved by the device, method and use defined in the independent patent claims. Further embodiments result from the dependent patent claims.

The invention relates to a sheet-like semi-finished product comprising:
a matrix comprising at least one latent reactive plastic composition, the plastic composition being curable to form an elastomer, in particular a thermoplastic elastomer,
continuous fibers embedded in the matrix, whereby the fibers are preferably aligned unidirectionally.

The sheet-like semi-finished product further comprises a thermoplastic film.

The term “embedding” refers to a macroscopic view, i.e. an external view. In particular, “embedding” means impregnating. The fibers are coated by the matrix. Coating can be done, for example, by spraying with the matrix or by drawing the fibers through a matrix solution.

In the context of this application, continuous filaments are all fibers with a length ≥50 mm.

The elastomer, in particular thermoplastic elastomer, can have soft and hard segments.

The thermoplastic film is preferably essentially inseparably bonded to the matrix, i.e. the film cannot be removed and reused. Rather, there is a permanent adhesion between the film and the matrix.

The semi-finished product according to the invention is characterized by improved stability, particularly in a direction transverse to the fiber. It was shown that although the thermoplastic layer, i.e. the film, itself has no fiber reinforcement, the tensile strength of the overall composite could be significantly increased. The positive mechanical properties of the fiber layer are thus transferred to the entire sheet-like semifinished product.

The plastic consistency of the melted thermoplastic adhesive layer can absorb the shearing forces.

In addition, the semi-finished product according to the invention has the advantage that a greater variety of substrates can be bonded. Surprisingly, good adhesion was found between the two layers—plastic matrix and thermoplastic film. Both a sufficiently good initial adhesion after drying of the latent reactive matrix and, above all, after bonding of the two substrates is given. Clever sequencing of these layers leads to an almost unlimited variety of substrates. For example, the semi-finished product according to the invention can be bonded to metal or unreinforced plastic to form composites.

Latent reactive plastic compositions have the advantage that the two processes of pre-coating and bonding can be easily separated.

The thermoplastic film can be a multilayer film. The multilayer film can have different surface properties, especially on its outer surfaces. This allows the semi-finished products to be adapted to the desired application.

The thermoplastic film can be composed of at least one non-polar layer comprising at least one apolar polymer and at least one polar layer comprising at least one polar polymer.

For the purposes of the application, apolar means a material and/or a surface which has a surface tension of less than 35 mN/m. For the purposes of the application, polar means a material and/or a surface which has a surface tension of more than 37 mN/m. The surface tension can be determined using commercially available test inks. Various test series are defined in accordance with DIN 53364. Another way to determine the surface tension is to measure the so-called contact or wetting angle. This involves measuring the angle between the surface and a drop of water. The better the wettability of the surface, the smaller the angle. The angle is measured using a goniometer, for example.

Preferably, the at least one polar layer faces the embedded continuous fibers in the matrix. A polar layer is particularly compatible with the matrix and thus forms a particularly stable composite.

Preferably, the at least one apolar polymer is selected from the group: polypropylene, modified polypropylene, polyethylene, modified polyethylene, polyoxymethylene, ethyl vinyl acetate, styrenic block copolymers, ionomers, olefins, rubbers or plastomers and copolymers thereof.

Preferably, the at least one polar polymer is selected from the group: polyamides, copolyamides, polyesters, copolyesters, polyurethanes, polyether block amides, acrylates or polycarbonates. Particularly preferably, the polar layer comprises or consists of acrylonitrile-butadiene-styrene copolymer (ABS) and its mixture with polycarbonates (ABS/PC), polyamides (PA) or polyurethanes (TPU).

The plastic composition may comprise polyurethanes and a latent reactive, in particular encapsulated, surface-deactivated or blocked isocyanate. A radiation-crosslinkable isocyanate would also be conceivable. The quantitative ratios between polyurethanes and isocyanate can vary. For example, the following compositions for surface-deactivated isocyanates are conceivable: For 100 parts by weight (pbw) of polyurethanes, 5 to 10 pbw of toluene-2, 4-diisocyanate dimer (TDI dimer) can be added. It is also possible to add 15 pbw isophorone diisocyanate trimer (IPDI trimer) to 100 pbw polyurethanes to prevent yellowing of the material. It is also possible to use a blocked isocyanate. For example, 2 to 15 pbw (dimethylpyrazole) blocked hexamethylene-4, 6-diisocyanate (HDI) trimer can be added to 100 pbw polyurethanes.

Due to the latent reactive isocyanate, there is no reaction between the isocyanate and the free OH groups of the polyurethanes at room temperature. The sheet-like semi-finished product can be stored at room temperature for a long period of time without any effort. The reaction process, i.e. the reaction with a surface-activated isocyanate, can take place by briefly initiating the reactions at low temperatures (<120° C.). However, blocked isocyanates can be used, which can only be activated at higher temperatures, for example at temperatures above 120°. The shaping process (e.g. pressing, vacuum bag process or in an autoclave) can still be kept short. Short cycle times can be used, which has a positive influence on the usable fibers. It is therefore also possible to use low-melting fiber types, such as polyamides, polyethylene or polyester.

The plastic composition may comprise polyurethanes and a latent reactive carbodiimide. Such plastic compositions are described in WO 99/29755 A1 and EP3730528 A1.

Preferably, the plastic composition is a dispersion, particularly preferably an aqueous dispersion. The plastic composition can also be present as a powder or melt. The dispersion can be applied, for example, by spraying, squeegeeing, soaking, infusion and/or vacuum infusion. However, the fibers can also be pulled through the dispersion solution and spread in the process. The dispersion promotes fiber spreading. This can increase the degree of wetting, which leads to optimum fiber incorporation and a high fiber content in the matrix.

The fibers can be based on protein, cellulose, synthetic polymers or inorganic substances.

Protein-based fibers can be selected from the group: wool, silk, angora, cashmere, casein, collagen, ardein and zein.

Cellulose fibers can be cotton and bast fibers such as cotton, linen, hemp or jute. Cellulose fibers can also be wood-based, such as viscose, modal, lyocell, cupro or acetate.

Fibers made of synthetic polymers can be selected from the group: polyethylene, polyester; polyamides; aramid; polypropylene; polyurethanes (elastane); acrylic; polytetrafluoroethylene; poly-phenylene-2, 6-benzobisoxazole; liquid crystal polymers (LCP), in particular poly(p-hydroxybenzoic acid-co-hydroxy-6-naphthoic acid).

The group of fibers made of inorganic substances includes carbon, ceramic, glass, quartz and metal.

The fibers may be embedded in the matrix as individual fibers or may have been previously spun into a thread and embedded as a thread. The fibers can also be processed into threads and then into a fabric, whereby the fabric is embedded. Filaments can also be embedded. Filaments are artificial fibers of any length. It is also conceivable that a combination of different fibers can be embedded.

The possibility of using different types of fibers has the advantage of opening up a wide range of applications. The properties of the product can be optimally adapted to the intended use.

The fibers are preferably arranged essentially in a longitudinal extension to a main surface of the semi-finished product. Preferably, the fibers are unidirectionally aligned. “Unidirectional” is understood here to mean that the longitudinal axes of the individual fibers run essentially parallel. By “essentially parallel” it is understood that the longitudinal axes of the fibers do not include angles of more than ±25° to each other. Preferably, the angles between the longitudinal axes of the fibers are less than ±10°.

Unidirectional semi-finished products have the advantage that they can be layered in a targeted manner along the force progression. If several sheet-like semi-finished products, each with unidirectionally aligned fibers, are layered and twisted in respect to each other, this results in a particularly high resistance to mechanical effects from different directions.

The fibers of the sheet-like semi-finished product are preferably spread. Spread fibers can be better wetted, the fiber incorporation and thus the fiber content are increased. A higher fiber content increases the performance of the fiber composite component. Fiber spreading also makes it possible to use different types of fibers in a semi-finished product. The use of different plastic compositions in a semi-finished product is also conceivable. This allows different properties to be combined in the material.

The thermoplastic film may contain further additives selected from the group: fillers, processing aids, stabilizers, dyes or combinations thereof. Possible fillers include, in particular, glass fibers, chalk or talc.

The matrix may also contain other additives selected from the group: thermoplastic polymers, fillers, processing aids, stabilizers, dyes or combinations thereof. Thermoplastic polymers can be, for example, polyolefins, ethyl acrylic acid (EAA), ethylene vinyl acetate (EVA), polyvinyl acetate (PVA), (co)polyesters, (co)polyamides, styrene copolymers, acrylates, polyvinyl alcohols or combinations thereof.

Another aspect of the invention relates to a method of manufacturing a sheet-like semi-finished product, in particular as previously described. The method comprises the steps of:
a) Embedding of fibers in a matrix comprising at least one latent reactive plastic composition which can be cured to form an elastomer,
b) Application of the embedded fibers to a thermoplastic film.

The thermoplastic film may be a multilayer film, in particular as described above.

The thermoplastic film may comprise at least one non-polar layer comprising at least one apolar polymer and at least one polar layer comprising at least one polar polymer. The apolar polymers may be selected from the group as described above. The polar polymers may be selected from the group as described above.

Preferably, the embedded fibers are applied to the at least one polar layer of the multilayer film.

Advantageously, the fibers are spread for embedding in step a). Spreading increases the degree of wetting of the fibers. The fiber incorporation is optimized. It is also possible to coat individual fibers with different plastic compositions. This allows further properties to be combined in the semi-finished product.

The spreading and impregnation of the fibers is described in WO 2018/234423 A1, the content of which is hereby incorporated into this application. The impregnated fibers can be placed on the thermoplastic adhesive layer before drying. For this purpose, the film is fed from below, the wet, aligned fibers are placed on it and the film/fiber combination is passed through an oven so that the matrix films (dries). The fibers thus form an adhesion of 0.1-1.0 N/mm, according to the T-Peel test based on DIN EN ISO 11339. This adhesion is sufficient to ensure further processing as a latent reactive fiber-reinforced adhesive layer without the fibers detaching from the film before the actual bonding.

The adhesion can be built up by cross-linking the matrix during the actual bonding step. The adhesion then increases to values of sometimes over 1.0 N/mm, especially if the chemistry of the matrix and that of the top film layer are compatible.

This manufacturing method results in even higher adhesion than if the film and the unidirectional fiber-reinforced adhesive layer are manufactured separately and are only placed on top of each other during bonding. The adhesion values are approx. 50% higher.

Without being bound to a theory, the improved adhesion could be due to the cross-linking process of the matrix. In a sandwich structure (stacking), the matrix must wet the film surface, for which a low viscosity is advantageous. At the same time, cross-linking begins with the bonding, which leads to an increase in viscosity. This means that optimum wetting is hindered by the wetting that takes place at the same time.

If, on the other hand, the matrix (and with it the fibers) is applied as a dispersion, the film is optimally wetted and retains the optimal wetting after the matrix has dried. Wetting and cross-linking are separated in time, which results in higher adhesion values with an otherwise identical chemical composition.

After step b), drying can take place at a maximum of 50° C., preferably at a maximum of 35° C.

It can also be advantageous if the film is pretreated before step b). The pre-treatment can be carried out with corona, plasma or flame treatment. The pre-treatment optimizes the wetting of the film. Pre-treatment can be particularly useful for a film with apolar polymers in order to ensure optimum wetting and adhesion.

Another aspect of the invention relates to a sheet-like semi-finished product, in particular as described above, producible by a method as described above.

Another aspect of the invention relates to the use of a sheet-like semi-finished product as described above for the manufacturing of clothing, vehicle components, tires, sports and leisure articles, tools, suitcases, machine components, drive and conveyor belts, packaging, building membranes, repair materials.

Another aspect of the invention relates to a composite material comprising a sheet-like semi-finished product as described above and a metal layer and/or a layer of a, preferably non-fiber-reinforced, plastic. The plastics can also be fiber-reinforced.

The metal layer can, for example, be made of aluminium, aluminium alloys, iron, iron alloys, in particular steel, galvanized steel and stainless steel, copper, copper alloys, titanium, titanium alloys, magnesium, magnesium alloys, tin, tin alloys, lead, lead alloys, bronze, brass. The metals can be painted, in particular KTL-painted, passivated, anodized, eloxated, galvanized, chrome-plated or otherwise surface-treated.

The non-fiber-reinforced plastic can be, for example, polyethylene, polypropylene, polyamides, polyester, polyoxymethylene, polystyrene, polyphthalamide, polyphenylene sulfide, polyether ketone, polyimide, polysulfone, polycarbonate, polymethyl acrylate, styrene acrylonitrile, acrylonitrile butadiene styrene, polyvinyl acetate, polyvinyl chloride, thermoplastic elastomers, rubber and mixtures thereof. The plastics can be reinforced with minerals, in particular calcium carbonate and talc, silica, kaolin, carbon black, glass beads, titanium dioxide, carbon nanotubes, elastomers and duromers.

The composite material can be manufactured using the process described above, whereby the sheet-like semi-finished product is additionally bonded to a metal layer and/or a layer of the, preferably non-fiber-reinforced, plastic.

The sheet-like semi-finished product according to the invention can be used for various bonding applications with other materials, enabling the production of different composite materials for different applications.

The invention is explained in more detail in the examples below. These are not to be understood as limiting.

### EXAMPLES

Dispersion 1 was an aqueous, anionic dispersion of aliphatic polyurethanes consisting of Dispercoll® U 56 (available from Covestro, Leverkusen, Germany) and surface-deactivated Desmodur® Z 2589 (available from Covestro, Leverkusen, Germany). The solids content was approx. 60%.

Dispersion 2 was an aqueous, anionic dispersion of aromatic polyurethanes consisting of Dispercoll® U 56 (available from Covestro, Leverkusen, Germany) and surface-deactivated Dispercoll® BL XP 2514 (available from Covestro, Leverkusen, Germany). The solids content was approx. 60%.

A flat film extruded from Hytrel® 4056 (available from DuPont, Willmington, USA) with a basis weight of 30 g/mª was used as the monofilm.

The multilayer film used was nolax® A22.5016, a PP/TPU film with a basis weight of 60g/m (available from nolax, Sempach-Station, Switzerland). Coating and bonding were carried out on the TPU side.

To impregnate the fibers, Twaron® filament yarn (available from Twaron Teijin, Arnhem, Netherlands) was spread over several deflection rollers on a fiber spreading machine. The spread fibers were then impregnated with an aqueous dispersion, formulation 1 or 2, using two coating rollers and deposited on the monofilm or multilayer film. This was followed by drying at a maximum temperature of 35° C.

The bonding was carried out on a Meyer stamping press at a temperature of 50° C. (pre-coatings without cross-linking) or 140° C. (bonding with cross-linking) with a pressing time of 2 minutes and a pressure of 5 bar. A non-elastic cotton textile was applied to the side of the thermoplastic adhesive layer using a suitable bonding agent. This was used to fix the adhesive layer in the T-Peel test.

For comparison, samples were also bonded with prefabricated latent reactive unidirectional tapes. These were placed separately on a BOPP carrier and placed on the adhesive layer after drying during the bonding process. They are therefore not pre-fixed.

The following samples were manufactured:

| | | | Fiber- | | |
|---|---|---|---|---|---|
| | | | reinforced | Thermoplastic | Pre- |
| Sample | fibers | matrix | film | film | fixing |
| A | — | — | Twaron with | Monofilm | No |
| | | | Disperion 1 | | |
| B | Twaron | Dispersion 1 | — | Monofilm | No |
| C | — | — | Twaron with | Monofilm | No |
| | | | Disperion 2 | | |
| D | Twaron | Dispersion 2 | — | Monofilm | No |
| E | — | — | Twaron with | Monofilm | Yes |
| | | | Disperion 1 | | |
| F | Twaron | Water | — | Monofilm | No |
| G | — | — | Twaron with | Multilayer | No |
| | | | Disperion 1 | film | |
| H | Twaron | Dispersion 1 | — | Multilayer | No |
| | | | | film | |

### T-Peel Tests

The T-Peel tests were carried out on a Zwick type 1120.25 tensile testing machine in accordance with DIN 53357 on 25 mm wide and 250 mm long test specimens at a pull-off speed of 100 mm/min at 23° C. and 50% relative humidity.

The following release strengths were determined:

| | Release strength |
|---|---|
| Sample | (N/cm) |
| A | 10.5 +/− 2.1 |
| B | 16.2 +/− 2.6 |
| C | 3.0 +/− 0.8 |
| D | 24.6 +/− 5.0 |
| E | 10.9 +/− 1.0 |
| F | 2.3 +/− 0.3 |
| G | 2.8 +/− 0.3 |
| H | 3.8 +/− 0.3 |

The comparisons of sample A with sample B, sample C with sample D, as well as sample G and sample H show the positive influence of spreading the fibers directly onto the hot melt adhesive film compared to laminating a prefabricated unidirectional fiber-reinforced adhesive layer onto the same hot melt adhesive film. The comparison of sample A with sample E shows that the same release strengths can be achieved by careful pre-coating with a latent reactive unidirectional fiber-reinforced adhesive layer and simultaneous pressing. However, a comparison with sample B shows that the wetting by pre-coating is not as good as when the fibers are applied directly to the film and the dispersion is dried on the film. This means that even with sample E, some of the optimum wetting is lost despite pre-coating due to the onset of cross-linking during the bonding process.

A comparison of sample B with sample F shows that a simple fixation of the fibers in the thermoplastic film produces significantly lower release strengths than with a matrix. The viscosity of the thermoplastic adhesive film is too high to enable good wetting of the fibers.

### Tensile Strain Tests

The following samples were manufactured:

| | | | Fiber- | | |
|---|---|---|---|---|---|
| | | | reinforced | Thermoplastic | Pre- |
| Sample | fibers | matrix | film | film | fixing |
| I | — | — | Twaron with | | No |
| | | | Disperion 1 | | |
| J | Twaron | Dispersion 1 | — | Monofilm | No |

Sample I is the unidirectional fiber-reinforced adhesive layer that was used in samples A, E and G. Sample J is sample B without cross-linking.

The following tensile strengths and elongations at break transverse to the grain direction were found:

| | | Elongation at break |
|---|---|---|
| | Tensile strength | transverse to the |
| Sample | (MPa) | fiber direction (%) |
| I | 0.56 +/− 0.15 | 0 |
| J | 23.43 +/− 2.56 | 1218 +/− 41 |

Pattern I breaks immediately at the start of the test.

Sample I clearly shows that a unidirectional fiber-reinforced adhesive layer without an adhesive film is very sensitive to loads transverse to the fiber direction, which makes the application technique challenging and the tape susceptible to damage.

Pattern J, on the other hand, shows tensile strength and elongation at break, as is usual for a thermoplastic adhesive layer.

The handling therefore does not differ from the processing of a film without fiber reinforcement.

1. A sheet-like semi-finished product comprising
a matrix comprising at least one latent reactive plastic composition, the plastic composition being curable to form an elastomer,
continuous fibers embedded in the matrix,
wherein the sheet-like semi-finished product further comprises a thermoplastic film.

2. The sheet-like semi-finished product according to claim 1, wherein the thermoplastic film is a multilayer film.

3. The sheet-like semi-finished product according to claim 2, wherein the thermoplastic film consists of at least one non-polar layer comprising at least one apolar polymer and at least one polar layer comprising at least one polar polymer.

4. The sheet-like semi-finished product according to claim 3, wherein the at least one polar layer faces the continuous fibers embedded in the matrix.

5. The sheet-like semi-finished product according to claim 3, wherein the at least one apolar polymer is selected from the group consisting of polypropylene, modified polypropylene, polyethylene, modified polyethylene, polyoxymethylene, ethyl vinyl acetate, styrenic block copolymers, ionomers, olefins, rubbers or plastomers and copolymers thereof.

6. The sheet-like semi-finished product according to claim 3, wherein the at least one polar polymer is selected from the group consisting of polyamides, copolyamides, polyesters, copolyesters, polyurethanes, polyether block amides, acrylates or polycarbonates.

7. The sheet-like semi-finished product according to claim 1, wherein the plastic composition comprises polyurethane and a latent reactive, in particular encapsulated, surface deactivated or blocked isocyanate.

8. The sheet-like semi-finished product according to claim 1, wherein the plastic composition comprises polyurethane and a latent reactive carbodiimide.

9. A process for manufacturing a sheet-like semi-finished product, comprising the steps of:
a) embedding of fibers in a matrix comprising at least one latent reactive plastic composition which can be cured to form an elastomer,
b) application of the embedded fibers to a thermo-plastic film.

10. The method according to claim 9, wherein the thermo-plastic film is a multilayer film.

11. The method according to claim 10, wherein the thermoplastic film consists of at least one non-polar layer comprising at least one apolar polymer and at least one polar layer comprising at least one polar polymer.

12. The method according to claim 11, wherein the embedded fibers are applied to the at least one polar layer of the multilayer film.

13. The method according to claim 9, wherein the fibers are spread before embedding in step a).

14. The method according to claim 9, wherein the film is pretreated before step b).

15. A method of using a sheet-like semi-finished product according to claim 1 for the manufacturing of clothing, vehicle components, tires, sports and leisure articles, tools, suitcases, machine components, building membranes, jewelry, drive and conveyor belts, packaging, construction materials, repair materials.

16. A composite material comprising a sheet-like semi-finished product according to claim 1 and at least one of a metal layer and/or a plastic layer.

17. The sheet-like semi-finished product according to claim 1, whereby the continuous fibers are aligned unidirectionally.

18. The sheet-like semi-finished product according to claim 1, whereby the elastomer is a thermoplastic elastomer.
